(19) United States
(12) Patent Application Publication
(10) Pub. No.: US 2008/0080841 A1
(43) Pub. Date: Apr. 3, 2008

(54) Information Processing Apparatus and Audio/Video Data Reproducing Method

(76) Inventors: Yuuichiro Aso, Hamura-shi (JP); Nobuaki Inomata, MIzuho-machi (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/832,866

(22) Filed: Aug. 2, 2007

(30) Foreign Application Priority Data
Sep. 29, 2006 (JP) 2006-268374

(51) Int. Cl. H04N 7/26

(52) U.S. Cl. 386/96; 386/109; 386/E05.001

(57) ABSTRACT

According to one embodiment, an information processing apparatus for decoding and reproducing compressed encoded audio data and video data includes an information adding device adding time stamp information to a frame of decoded video data, the time stamp information indicating a time when the frame is to be reproduced, and a level control device monitoring a delay time of the time when the frame is to be reproduced from a time when audio data corresponding to the frame is reproduced, and lowering a decode processing level during decoding of frames of the compressed encoded video data when the delay time becomes equal to or longer than a predetermined threshold value.

### CROSS-REFERENCE TO RELATED APPLICATIONS

This application is based upon and claims the benefit of priority from Japanese Patent Application No. 2006268374, filed Sep. 29, 2006, the entire contents of which are incorporated herein by reference.

### BACKGROUND

1. Field

One embodiment of the invention relates to an information processing apparatus and an audio/video data reproducing method for decoding and reproducing compressed encoded audio data and video data.

2. Description of the Related Art

In recent years, there are developed information processing apparatuses such as a personal computer having an AV function that is equivalent to an audio/video (AV) apparatus such as a DVD (Digital Versatile Disc) player or a TV apparatus. In such an information processing apparatus, generally a software decoder is used, which decodes compressed encoded audio data and video data by software. The use of a software decoder enables decoding of compressed encoded audio data and video data by a processor (CPU) without providing dedicated hardware.

As a conventional software decoder, there exists a decoder which skips format conversion processing of video data for a predetermined number of frames when a delay occurs in decode processing of compressed encoded video data, and increases the number of frames to be skipped when the delay continues further, so as to realize a synchronous reproduction of audio data and video data (for example, refer to Japanese Patent Application Publication (KOKAI) No. 2001-128171).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of a personal computer according to an embodiment of the invention;

FIG. 2 is an exemplary block diagram showing a system configuration of the personal computer shown in FIG. 1 in the embodiment;

FIG. 3 is an exemplary block diagram showing a configuration of a software decoder realized by an audio/video reproduction application shown in FIG. 2 in the embodiment;

FIG. 4 is an exemplary block diagram showing a configuration of a video decoder shown in FIG. 3 in the embodiment; and

FIG. 5 is an exemplary flowchart showing a procedure of decode processing executed by the audio/video reproduction application shown in FIG. 2 in the embodiment

### DETAILED DESCRIPTION

Various embodiments according to the invention will be described hereinafter with reference to the accompanying drawings. In general, according to one embodiment of the invention, an information processing apparatus for decoding and reproducing compressed encoded audio data and video data includes an information adding device adding time stamp information to a frame of decoded video data, the time stamp information indicating a time when the frame is to be reproduced, and a level control device monitoring a delay time of the time when the frame is to be reproduced from a time when audio data corresponding to the frame is reproduced, and lowering a decode processing level during decoding of frames of the compressed encoded video data when the delay time becomes equal to or longer than a predetermined threshold value.

Hereinafter, preferred embodiments of the invention will be described in detail with reference to the drawings. Note that identical or corresponding parts in the respective drawings are designated the same reference numerals, and duplicating explanations thereof are omitted.

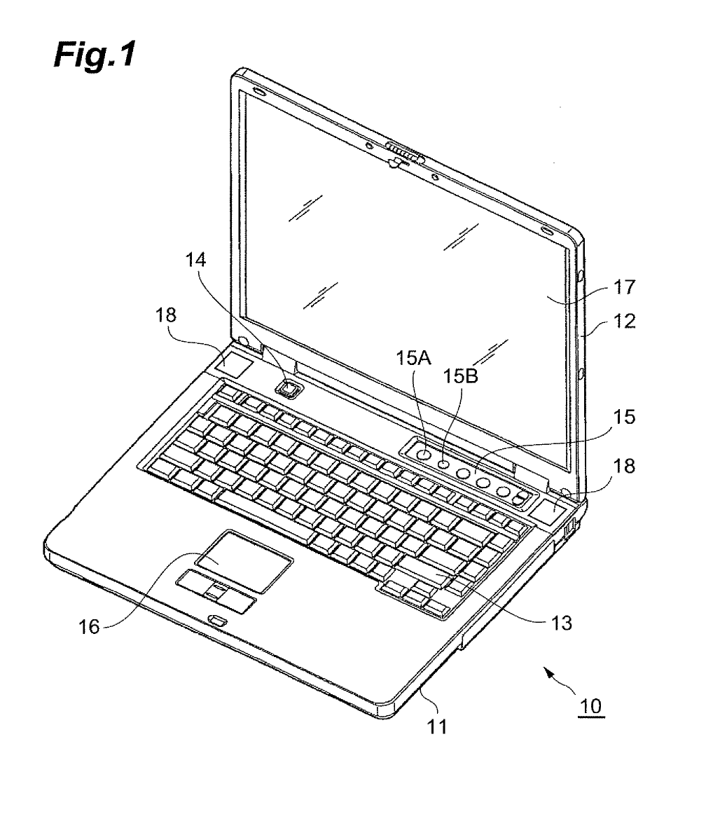

As shown in FIG. 1, a notebook type personal computer (information processing apparatus) 10 is constituted of a computer body 11 and a display unit 12. A display device constituted of an LCD (Liquid Crystal Display) 17 is incorporated in the display unit 12, and a display screen of the LCD 17 is located substantially in the center of the display unit 12.

The display unit 12 is attached on the computer body 11 to be capable of turning between an open position and a close position relative to the computer body 11. The computer body 11 has a case in a thin box shaper and on an upper surface thereof, a keyboard 13, a power button 14 for turning on/off the power of the personal computer 10, an input operation panel 15, a touch pad 16, a speaker 18, and so forth are arranged.

The input operation panel 15 is an input device for inputting an event corresponding to a pressed button, and includes a plurality of buttons for activating a plurality of functions, respectively. This group of buttons includes a TV activating button 15A and a DVD activating button 15B. The TV activating button 15A is a button for activating a TV function for reproducing and recording broadcast program data of a digital TV broadcast program or the like. When the TV activating button 15A is pressed by the user, an application program for executing a TV function is activated automatically. The DVD activating button 15B is a button for reproducing video contents recorded in a DVD. When the DVD activating button 15B is pressed by the user, an application program for reproducing video contents is activated automatically.

Next, a system configuration of the personal computer 10 will be explained.

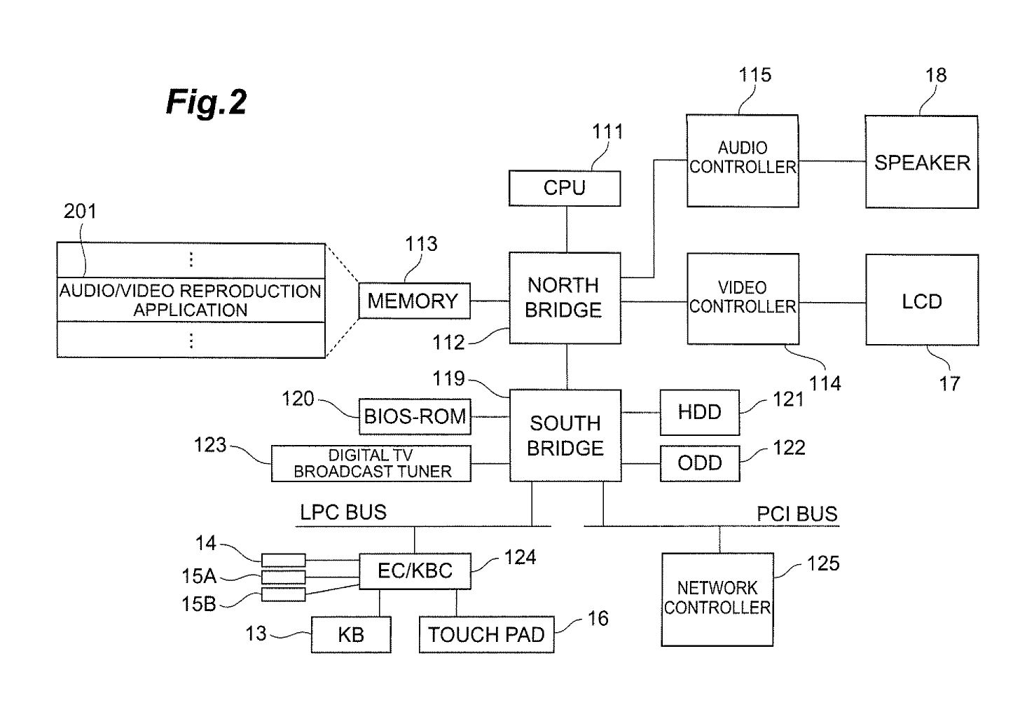

As shown in FIG. 2, the personal computer 10 includes a CPU 111, a north bridge 112, a main memory 113, a video controller 114, an audio controller 115, a south bridge 119, a BIOS-ROM 120, a hard disk drive (HDD) 121, an optical disk drive (ODD) 122, a digital TV broadcast tuner 123, an embedded controller/keyboard controller IC (EC/KBC) 124, a network controller 125, and so forth.

The CPU 111 is a processor provided for controlling operations of the personal computer 10, and executes various application programs such as an operating system (OS) and an audio/video reproduction application 201, which are loaded from the HDD 121 to the main memory 113.

The audio/video reproduction application 201 is a software decoder for decoding and reproducing compressed encoded audio data and video data. The audio/video reproduction application 201 has a function to decode compressed encoded audio data and video data (of a digital TV broadcast program received by the digital TV tuner 123, video contents of HD (High Definition) standard read from the ODD 122, or the like for example).

Further, the CPU 111 also executes a system BIOS (Basic Input Output System) stored in the BIOS-ROM 120. The system BIOS is a program for controlling hardware.

The north bridge 112 is a bridge device connecting a local bus of the CPU 111 and the south bridge 119. The north bridge 112 includes a memory controller for controlling access to the main memory 113. Further, the north bridge 112 also has a function to execute communication with the video controller 114 via an AGP (Accelerated Graphics Port) bus or the like and communication with the audio controller 115.

The video controller 114 is a video reproduction controller controlling the LPCD 17 used as a display monitor of the personal computer 10. The video controller 114 generates a reproduction signal to be transmitted to the LCD 17 from decoded video data.

The audio controller 115 is an audio reproducing controller controlling the speaker 18 of the personal computer 10. The audio controller 115 generates a reproduction signal to be transmitted to the speaker 18 from decoded audio data.

The south bridge 119 controls respective devices on an LPC (Low Pin Count) bus and respective devices on a PCI (Peripheral Component Interconnect) bus. Further, the south bridge 119 includes an IDE (Integrated Drive Electronics) controller for controlling the HDD 121 and the ODD 122. Further, the south bridge 119 also has a function to control the digital TV broadcast tuner 123 and a function to control access to the BIOS-ROM 120.

The HDD 121 is a storage device storing various software and data. The ODD 122 is a drive unit for driving a storage medium such as DVD storing video contents. The digital TV broadcast tuner 123 is a receiving device for receiving from the outside broadcast program data of a digital TV broadcast program or the like.

The EC/KBC 124 is a one-chip microcomputer in which an embedded controller for managing power and a keyboard controller for controlling the keyboard (KB) 13 and the touch pad 16 are integrated. This EC/KBC 124 has a function to turn on/off power of the personal computer 10 according to an operation of the power button 14 by the user. Further, the EC/KBC 124 can turn on the power of the personal computer 10 according to an operation of the TV activating button ISA or is the DVD activating button 15B by the user. The network controller 125 is a communication device for executing communication with an external network such as the Internet for example.

Next, a configuration of the software decoder realized by the audio/video reproduction application 201 will be explained.

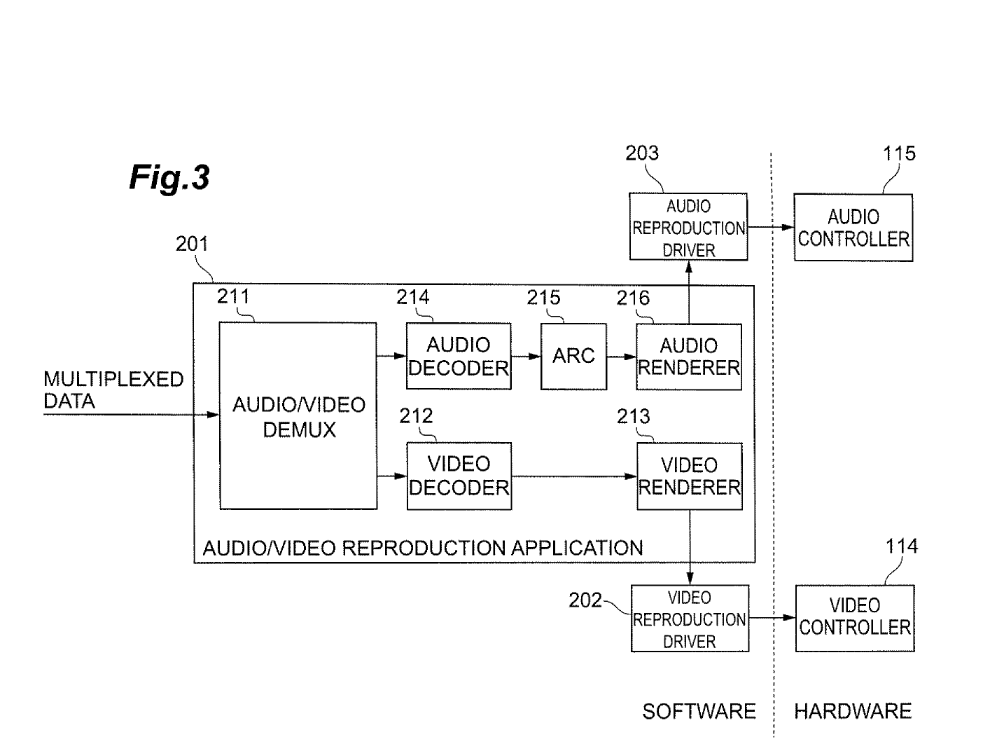

As shown in FIG. 3, the audio/video reproduction application 201 includes an audio/video demux 211, a video decoder 212, a video renderer 213, an audio decoder 214, an ARC 215 and an audio renderer 216.

The audio/video demux 211 has a function to read multiplexed data of video contents in a DVD driven by the ODD 122 for example, and separate the data into compressed encoded audio data and compressed encoded video data. Also, the audio/video demux 211 has a function to manage compressed encoded audio data and transmit the data to the audio decoder 214, and a function to manage compressed encoded video data and transmit the data to the video decoder 212.

The video decoder 212 has a function to decode respective frames of the video data transmitted by the audio/video demux 211. The video renderer 213 has a function to output the video data decoded by the video decoder 212 to the video controller 114 via a video reproduction driver 202. Thus, the video data is reproduced via the LCD 17 of the personal computer 10. Note that the video reproduction driver 202 is software for controlling the video controller 114.

The audio decoder 214 has a function to decode the audio data transmitted by the audio/video demux 211. The ARC 215 has a function as an amplifier to amplify the audio data decoded by the audio decoder 214. The audio renderer 216 has a function to output the audio data decoded by the audio decoder 214 and amplified by the ARC 215 to the audio controller 115 via an audio reproduction driver 203. Thus, the audio data is reproduced via the speaker 18 of the personal computer 10. Note that the audio reproduction driver 203 is software for controlling the audio controller 115.

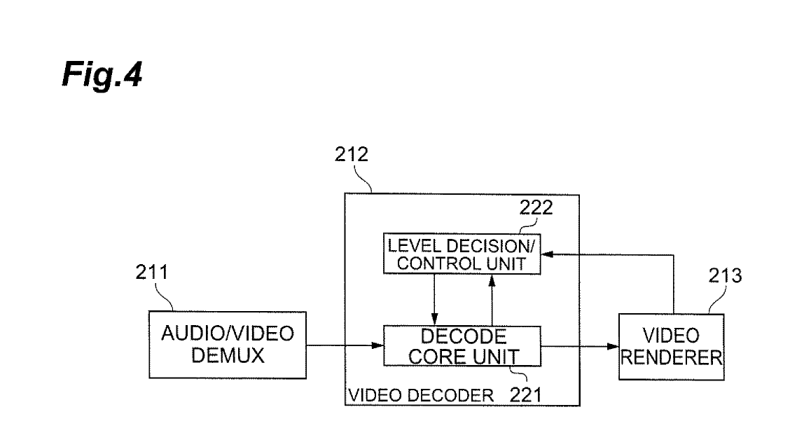

As shown in FIG. 4, the video decoder 212 includes a decode core unit (information adding device) 221 and a level determination/control unit (level control device) 222.

The decode core unit 221 has a function to decode respective frames of the video data transmitted by the audio/video demux 211, and add time stamp information to a frame of the decoded video data, the time stamp information indicating a time when the frame is to be reproduced.

The level determination/control unit 222 has a function to monitor a delay of a time (hereinafter simply referred to as “delay time”) when the frame to which the time stamp information is added is to be reproduced (in other words, a time shown by the time stamp information) from a time when audio data corresponding to the frame is reproduced (so-called stream time). Further, the level determination/control unit 222 has a function to determine a decode processing level when decoding a frame of compressed encoded video data with a predetermined condition, and set the determined decode processing level to the decode core unit 221.

Here, the video renderer 213 has a function to obtain a time indicated by the time stamp information added to each frame and a time when audio data corresponding to each frame to which the time stamp information is added is reproduced, and feed back the times to the level determination/control unit 222.

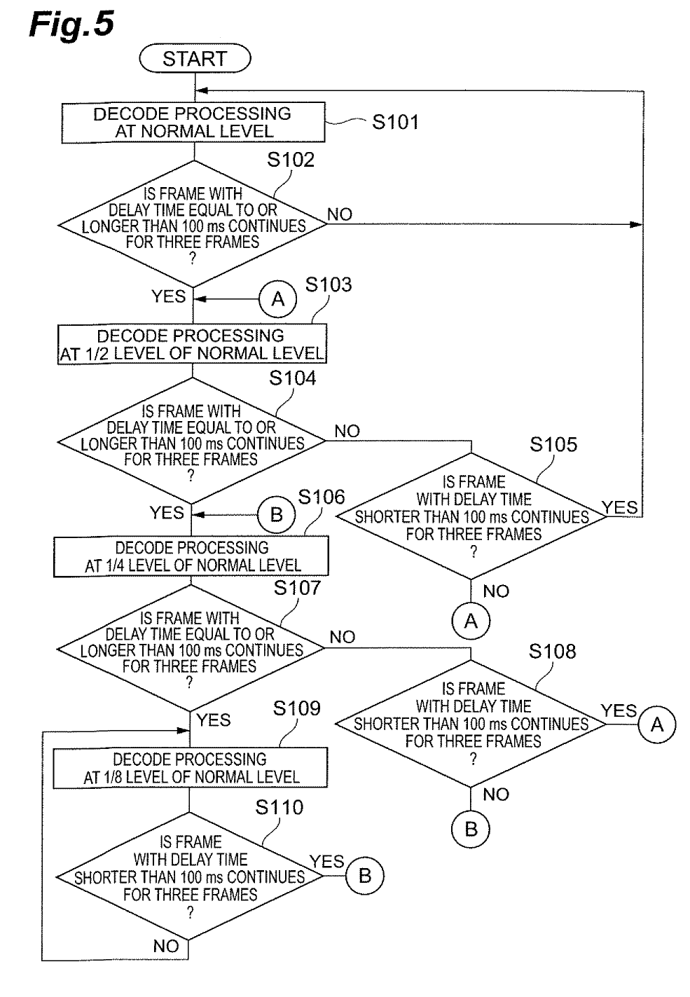

Next, with reference to a flowchart of FIG. 5, a procedure of decode processing executed by the audio/video reproduction application 201 will be explained.

First, the decode core unit 221 performs decode processing of video data at a normal decode processing level (block S101). At this time, the level determination/control unit 222 determines whether or not a frame with a delay time equal to or longer than a predetermined threshold value (here, 100 ms) continues for a predetermined number of frames (here, three frames) (block S102). Note that the predetermined threshold value and the predetermined number of frames may be changed appropriately.

As a result of determination in block S102, when the frame did not continue, the decode processing of the video data is carried on at the normal decode processing level (block S101).

On the other hand, when the frame continued as a result of the determination in block S102, the level determination/control unit 222 performs setting of the decode processing level on the decode core unit 221 so that the decode core unit 221 performs the decode processing of the video data at a decode processing level of ½ of the normal level (block S103). In other words, the decode processing level in the video decoder 212 is lowered by one step. Note that the decode core unit 221 lowers the decode processing level by omitting a part of the decode processing (for example, deblocking filter processing) of frames of compressed encoded video data.

Subsequently, the level determination/control unit 222 determines whether or not a frame with a delay time equal to or longer than 100 ms continues for three frames (block S104).

As a result of the determination in block S104, when the frame did not continue, it is determined whether or not a frame with a delay time shorter than 100 ms continues for three frames (block S105). As a result, when the frame did not continue, the decode processing of the video data is carried on at a decode processing level of ½ of the normal level (block S103). On the other hand, when the frame continued, the level determination/control unit 222 performs setting of the decode processing level on the decode core unit 221 so that the decode core unit 221 performs the decode processing of the video data at the normal decode processing level (block S101). In other words, the decode processing level in the video decoder 212 is raised by one step.

On the other hand, when the frame continued as a result of the determination in block S104, the level determination/control unit 222 performs setting of the decode processing level on the decode core unit 221 so that the decode core unit 221 performs the decode processing of the video data at a decode processing level of ¼ of the normal level (block S106). In other words, the decode processing level in the video decoder 212 is lowered further by one step.

Subsequently, the level determination/control unit 222 determines whether or not a frame with a delay time equal to or longer than 100 ms continues for three frames (block S107).

As a result of the determination in block S107, when the frame did not continue, it is determine whether or not a frame with a delay time shorter than 100 ms continues for three frames (block S108). As a result, when the frame did not continue, the decode processing of the video data is carried on at a decode processing level of ¼ of the normal level (block S106). On the other hand, when the frame continued, the level determination/control unit 222 performs setting of the decode processing level on the decode core unit 221 so that the decode core unit 221 performs the decode processing of the video data at a decode processing level of ½ of the normal level (block S103). In other words, the decode processing level in the video decoder 212 is raised by one step.

On the other hand, when the frame continued as a result of the determination in block S107, the level determination/control unit 222 performs setting of the decode processing level on the decode core unit 221 so that the decode core unit 221 performs the decode processing of the video data at a decode processing level of ⅛ of the normal level (block S109). In other words, the decode processing level in the video decoder 212 is lowered further by one step.

Subsequently, the level determination/control unit 222 determines whether or not a frame with a delay time shorter than 100 ms continues for three frames (block S110).

As a result of the determination in block S111, when the frame did not continue, the decode processing of the video data is carried on at a decode processing level of ⅛ of the normal level (block S109).

On the other hand, when the frame continued as a result of the determination in block S111, the level determination/control unit 222 performs setting of the decode processing level on the decode core unit 221 so that the decode core unit 221 performs the decode processing of the video data at a decode processing level of ¼ of the normal level (block S106). In other words, the decode processing level in the video decoder 212 is raised by one step.

As described above, in the personal computer 10, the decode core unit 221 adds time stamp information to a frame of decoded video data, the time stamp information indicating a time when the frame is to be reproduced, and when a frame with a delay time (delay of a time when a frame to which the time stamp information is added is to be reproduced from a time when audio data corresponding to the frame is reproduced) equal to or longer than a predetermined threshold value continues for a predetermined number of frames, the level determination/control unit 222 lowers the decode processing level in the video decoder 212 in a step-by-step manner. In this manner, in the personal computer 10, when a possibility of occurrence of sound skipping during reproduction of sound data and video data increases due to insufficient resources or reproduction of video contents with a high bit rate, it is possible to lower a decode processing level for decode processing of video data that generates a higher load than decode processing of audio data does. Accordingly, even when resources are lacking or reproducing video contents with a high bit rate, the load applied on the personal computer 10 can be decreased, and a delay of reading of compressed encoded audio data and video data to the audio/video demux 211 can be prevented. Therefore, with the personal computer 10, it becomes possible to prevent occurrence of sound skipping during reproduction of audio data and video data.

Further, in the personal computer 10, the level determination/control unit 222 lowers the decode processing level in the video decoder 212 when a frame with a delay time equal to or longer than a predetermined threshold value continues for a predetermined number of frames. In this manner, by setting a condition for lowering the decode processing level to a case that a delayed frame continues for a predetermined number of frames, it is possible to prevent lowering of the decode processing level in a case that a delay of only one frame occurs accidentally by a certain kind of cause.

Moreover, in the personal computer 10, the level determination/control unit 222 lowers the decode processing level in the video decoder 212 in a step-by-step manner. Accordingly, when reproducing audio data and video data, it is possible to prevent significant deterioration of image quality while suppressing occurrence of sound skipping.

Further, in the personal computer 10, the level determination/control unit 222 raises the decode processing level in the video decoder 212 in a step-by-step manner when a frame with a delay time shorter than a predetermined threshold continues for a predetermined number of frames. Accordingly, when the load applied on the personal computer 10 decreases, the image quality can be improved during reproduction of video data.

The present invention is not limited to the above described embodiments.

For example, the above-described embodiments are of a case such that the decode core unit 221 lowers the decode processing level by omitting a part of the decode processing of frames of compressed encoded video data, but the decode core unit 221 may lower the decode processing level by omitting all the decode processing of frames of compressed encoded video data (in other words, by thinning frames of compressed encoded video data) When thinning frames of compressed encoded video data, it is preferable that the thinning is performed in a step-by-step manner by one frame, two frames, three frames, and so on to lower the processing level. Then, when thinning two frames or three frames, it is preferable that the thinning is performed in a discontinuous manner rather than a continuous manner so as to reduce unpleasant feeling given to the user. Note that both the omitting of a part of the decode processing or omitting of all the decode processing of frames of compressed encoded video data may be performed in one decode processing.

Also, the above-described embodiments are of a case that the decode processing level is lowered or raised between a normal decode processing level, a decode processing level of ½ of the normal level, a decode processing level of ¼ of the normal level, and a decode processing level of ⅛ of the normal level, but the lowering and raising of the decode processing level may be performed at predetermined intervals, or may be performed between a maximum value and a minimum value.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus for decoding and reproducing compressed encoded audio data and video data, the apparatus comprising:
an information adding device adding time stamp information to a frame of decoded video data, the time stamp information indicating a time when the frame is to he reproduced; and
a level control device monitoring a delay time of the time when the frame is to be reproduced from a time when audio data corresponding to the frame is reproduced, and lowering a decode processing level during decoding of frames of the compressed encoded video data when the delay time becomes equal to or longer than a predetermined threshold value.

2. The information processing apparatus according to claim 1, wherein said level control device lowers the decode processing level when the frame with the delay time equal to or longer than the predetermined threshold value continues for a predetermined number of times.

3. The information processing apparatus according to claim 1, wherein said level control device lowers the decode processing level in a step-by-step manner.

4. The information processing apparatus according to claim 1, wherein said level control device lowers the decode processing level by omitting a part of decode processing of frames of compressed encoded video data.

5. The information processing apparatus according to claim 1, wherein said level control device lowers the decode processing level omitting by omitting all decode processing of frames of compressed encoded video data.

6. The information processing apparatus according to claim 1, wherein said level control device increases the decode processing level when the delay time becomes shorter than the predetermined threshold value.

7. The information processing apparatus according to claim 6, wherein said level control device increases the decode processing level when the frame with the delay time shorter than the predetermined threshold value continues for a predetermined number of frames.

8. The information processing apparatus according to claim 6, wherein said level control device increases the decode processing level in a step-by-step manner.

9. An audio/video data reproducing method for decoding and reproducing compressed encoded audio data and video data, comprising:
an information adding step of adding time stamp information to a frame of decoded video data, the time stamp information indicating a time when the frame is to be reproduced; and
a level control step of monitoring a delay time of the time when the frame is to be reproduced from a time when audio data corresponding to the frame is reproduced, and lowering a decode processing level during decoding of frames of the compressed encoded video data when the delay time becomes equal to or longer than a predetermined threshold value.
